(19) United States
(12) Patent Application Publication
(10) Pub. No.: US 2009/0185197 A1
(43) Pub. Date: Jul. 23, 2009

(54) Control Of Motors In An Image Forming Device

(76) Inventors: Michael Hayes Wilson, Lexington, KY (US); William Paul Cook, Lexington, KY (US); Thomas Austin Fields, Winchester, KY (US); Daniel L. Carter, Georgetown, KY (US)

Correspondence Address: John J. McArdle, Jr.;Lexmark International, Inc., Intellectual Property Department, 740 West New Circle Road, Lexington, KY, 40550, US

(21) Appl. No.: 12/017,554

(22) Filed: Jan. 22, 2008

(51) Int. Cl. G06F 3/12

(52) U.S. Cl. 358/1.1

(57) ABSTRACT

The present application is directed to methods and devices for controlling a motor in an image forming device by sensing the amount of current applied to the motor. One embodiment includes a power supply operatively connected to a controller. The power supply provides an electrical current to a motor, and the amount of current is measured. The controller monitors the amount of current and determines an operating condition of the motor based on the current. The controller may then continue to allow the power supply to provide the electrical current to the motor, or may shut off the current based on the operating condition. The controller may also monitor a timer to determine how long the power supply has provided current to the motor. In one embodiment, the controller may use both the signal and monitored time to determine the operating condition of the motor.

### BACKGROUND

The present application is directed to methods and devices for controlling operation of an image forming device and, more specifically, to controlling the operation of motors in the image forming device.

Image forming devices, such as but not limited to printers, copiers, facsimile machines, and all-in-one machines, include one or more motors to operate a variety of components and subsystems. These components and subsystems may include, for example, a pick mechanism to pick a media sheet from an input tray, conveyor systems to transport the media sheet within the image forming device, photoconductor drums, and developer rollers. The motor may function to drive the conveyor system or rotate the photoconductor drums and developer rollers. The motor may also be used to move a photoconductor unit or a portion of the conveyor system into place. Additionally, latch mechanisms may be engaged and disengaged by the motor. Each motor may require some level of control to ascertain that it has accomplished its intended function.

In order to control the motor, a sensor is often required to sense how the motor is performing. For example, an encoder may be used to count the revolutions of the motor or to determine its rotational speed. Position sensors may be used to sense the position of a component being moved by the motor to determine if the component has moved properly. Various other sensors may be used as is known in the art to directly monitor the motor or to monitor the function being performed by the motor. These types of sensors may increase the cost and complexity of the image forming device. In addition, more complex sensors that produce a variable signal may require frequent calibration which may affect reliability and may increase maintenance requirements. Image forming devices, however, should be constructed in an economical manner without adversely impacting reliability.

### SUMMARY

The present application is directed to methods and devices for controlling a motor in an image forming device by sensing the amount of current applied to the motor. One embodiment includes a power supply operatively connected to a controller. The power supply provides an electrical current to a motor, and the amount of current is measured. The controller monitors the amount of current and determines an operating condition of the motor based on the current. The controller may then continue to allow the power supply to provide the electrical current to the motor, or may shut off the current based on the operating condition. The controller may also monitor a timer to determine how long the power supply has provided current to the motor. In one embodiment, the controller may use both the signal and monitored time to determine the operating condition of the motor.

### BRIEF DESCRIPTION OF THE DRAWINGS

FIG. 1 is a schematic diagram of a motor control system according to one embodiment.

FIG. 2 is a schematic diagram of an image forming device according to one embodiment.

FIG. 3 is a flow diagram of a method for controlling a motor in an image forming device according to one embodiment.

FIG. 4 is a perspective view of a motor and its associated subsystem in an image forming device according to one embodiment.

FIG. 5 is a flow diagram of a method for controlling a motor in an image forming device according to one embodiment.

### DETAILED DESCRIPTION

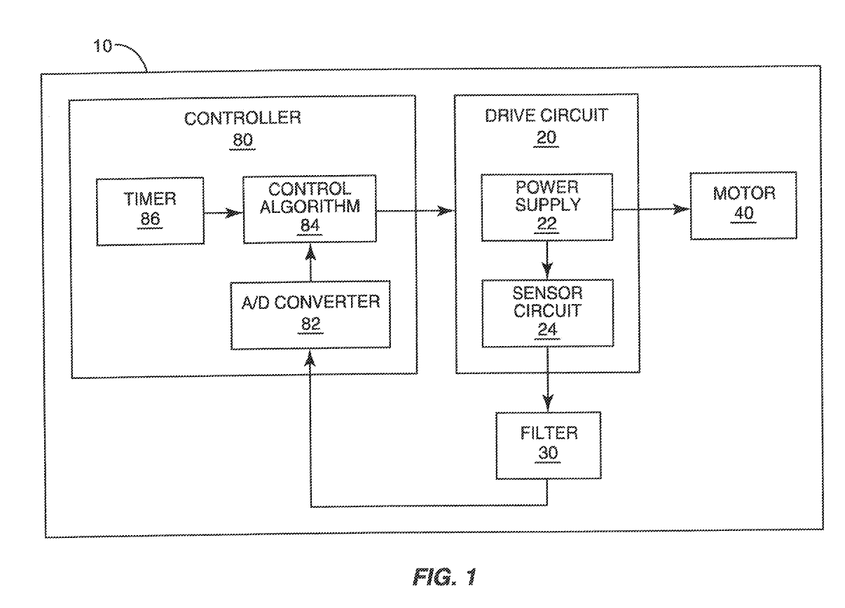

The present application is directed to methods and devices for controlling a motor in an image forming device by sensing the amount of current applied to the motor. One embodiment as schematically illustrated in FIG. 1 includes an image forming device 10 with a power supply 22 operatively connected to a controller 80. The power supply 22 generates a voltage that provides an electrical current to a motor 40. A sensor circuit 24 monitors a characteristic of the current and sends a signal responsive to the characteristic to the controller 80. The controller 80 monitors the signal and determines an operating condition of the motor 40 based on the signal. The controller 80 may then continue to allow the power supply 22 to provide the electrical current to the motor 40, or may shut off the current based on the operating condition. The controller 80 may also monitor a timer 86 to determine how long the power supply 22 has provided current to the motor 40. In one embodiment, the controller 80 may use both the signal and monitored time to determine the operating condition of the motor 40.

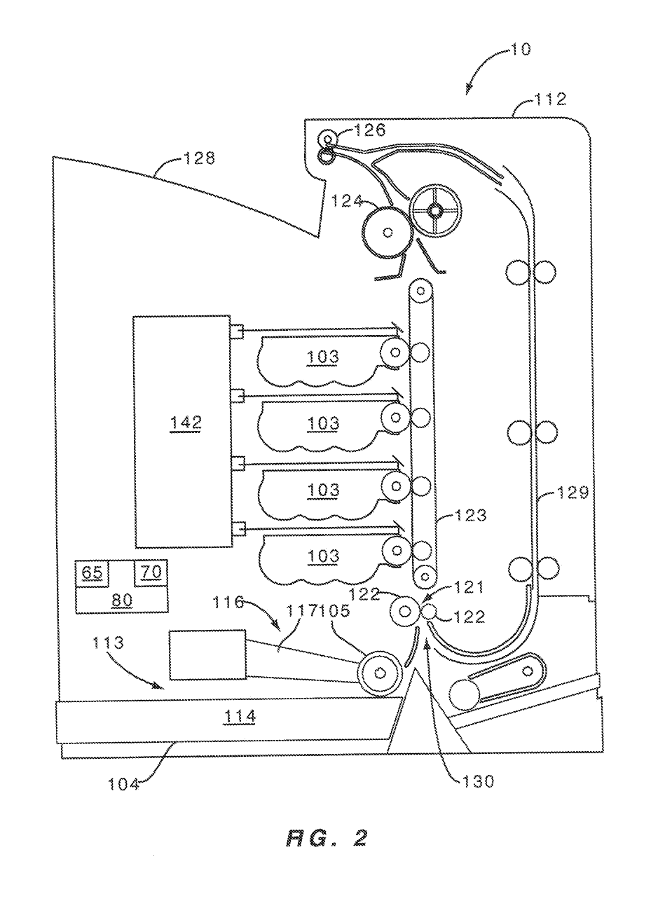

The methods and devices may be implemented in the image forming device 10 generally illustrated in FIG. 2 and may be implemented in various embodiments disclosed herein. The image forming device 10 comprises an input area 113 that includes a media tray 104 sized to hold a stack of media sheets 114. The media tray 104 may be disposed in a lower portion of a main body 112 of the image forming device 10, and is preferably removable for refilling. A pick mechanism 116 moves media sheets 114 from the media tray 104 into the media path 130. Pick mechanism 116 comprises a pivoting arm 117 and a pick tire 105 that rests on the top-most sheet 114 in the stack. Pick mechanism 116 picks the top-most media sheet 114 from the stack and moves the media sheet 114 into the media path 130.

A registration nip 121 formed between rollers 122 aligns the media sheet 114 prior to passing to a transport belt 123 and past a series of image forming stations 103. A laser assembly 142 forms a latent image on a photoconductive member in each image forming station 103. Toner is then transferred to the photoconductive members to form toner images. The toner images are then transferred from the image forming stations 103 to the passing media sheet 114.

Color image forming devices typically include four image forming stations 103 for printing with cyan, magenta, yellow, and black toner to produce a four-color image on the media sheet 114. The transport belt 123 conveys the media sheet 114 with the color image thereon towards a fuser 124, which fixes the color image on the media sheet 114. Exit rollers 126 either eject the media sheet 114 to an output tray 128, or direct it into a duplex path 129 for printing on a second side of the media sheet 114. In the latter case, the exit rollers 126 partially eject the media sheet 114 and then reverse direction to invert the media sheet 114 and direct it into the duplex path 129. A series of rollers in the duplex path 129 return the inverted media sheet 114 to the primary media path 130 for printing on the second side of the media sheet 114.

The controller 80 oversees operation of the image forming device 10 including the timing of the toner images and movement of the media sheets 114. In one embodiment, the controller 80 includes a microprocessor 65 and memory 70. In one embodiment, the controller 80 includes random access memory, read only memory, and an input/output interface. The controller 80 may also monitor the location of the toner images on the photoconductive members. In one embodiment, the controller 80 monitors scan data from the laser assembly and the number of revolutions and rotational position of the one or more motors that drive the photoconductive members.

The controller 80 further tracks the position of media sheets 114 moving along the media path 130. The media path 130 includes a series of rollers and/or belts 123 that are rotated by one or more motors to control the speed and position of each media sheet 114. The original position of the media sheets 114 may be detected as they move past one or more sensors (not shown). The controller 80 may track the incremental position of the media sheets 114 based on the number of revolutions and rotational positions of the roller and/or belt motor(s). One embodiment of a controller 80 that tracks the operation of the image forming device is disclosed in U.S. Patent No. 6,330,424, herein incorporated by reference.

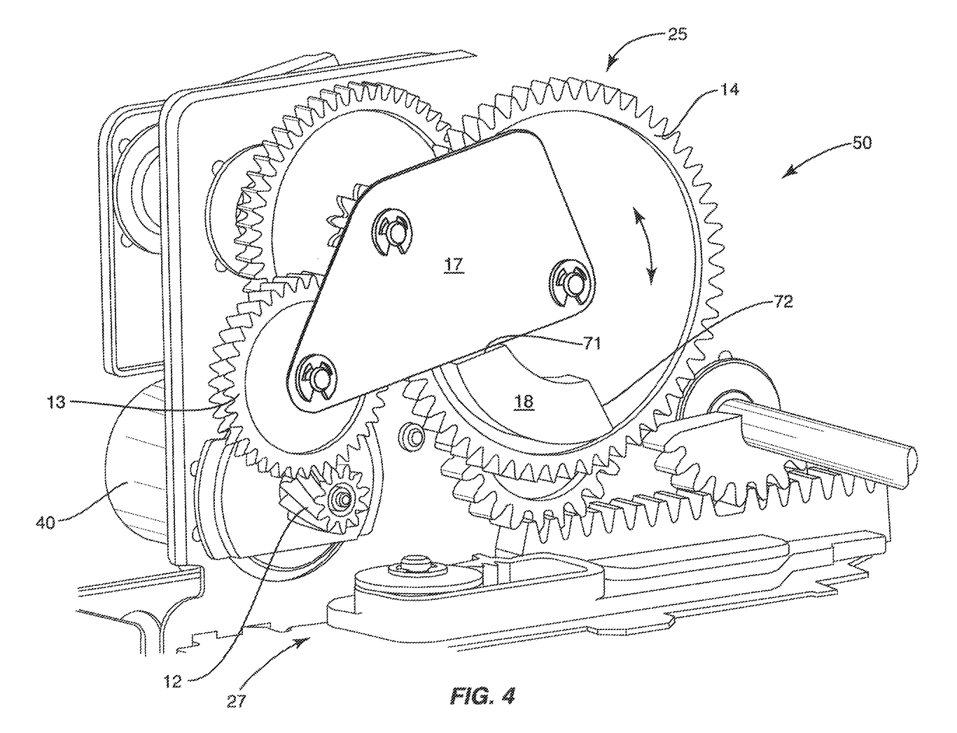

The image forming device 10 may include a variety of motors each operatively connected to a subsystem (or component) of the image forming device 10 (see, for example, FIG. 4). In one embodiment, the image forming device 10 includes one or more doors that provide internal access. A motor 40 may operate a subassembly similar to that illustrated in FIG. 4 to move a latch that locks the doors in place when the image forming device 10 is in an operating mode. In another embodiment, the image forming device 10 may include another subsystem similar to that illustrated in FIG. 4 to move a retraction assembly that couples and decouples the photoconductive member from the main body 112. Specific examples of these two embodiments are illustrated in U.S. patent application Ser. No. 11/964,388 filed on Dec. 26, 2007, which is herein incorporated by reference. By way of nonlimiting example, other subsystems and components in an image forming device 10 that may be operatively connected to a motor 40 include the pick mechanism, conveyor drive system, engaging and disengaging mechanisms for specific drive rollers or developer rollers, toner stirrers within a toner cartridge, and waste toner augers. In order for the image forming device 10 to operate properly, each of these motors 40 may require a motor control.

In one embodiment, the motor 40 is a brush DC motor. For this type of motor 40, the amount of current applied to the motor 40 is directly proportional to the amount of torque generated by the motor 40. Thus, the amount of torque generated by the motor 40 may be determined by measuring the current applied to the motor 40. The measure of the current may then be used to determine when the motor 40 is applying an amount of torque greater than what would be expected when the motor 40 is running under normal conditions for its intended function. For example, an increase in current applied to the motor 40 may indicate that the component being driven by the motor 40 has reached the end of its intended travel, or it may indicate that a jam has occurred that is preventing the component from moving. Similarly, an absence of an increase in current applied to the motor 40 may indicate that the component has not reached the end of its intended travel. One skilled in the art would recognize that similar indications of the level of torque could be determined for other types of motors, for example brushless DC motors and linear motors.

The following provides a more detailed discussion of the motor control methods and devices of the present application as may be applied to these motors 40. Referring again to FIG. 1, the controller 80 enables a drive circuit 20 to provide electrical current to the motor 40 from the power supply 22. Note that FIG. 1 illustrates the power supply 22 as part of the drive circuit 20; however, the power supply 22 may also be separate form the drive circuit 20. The sensor circuit 24 monitors the current supplied to the motor 40 and generates a signal proportional to the current. In one embodiment, the sensor circuit 24 includes a resistor positioned across a circuit providing the motor current. The signal comprises a voltage drop measured across the resistor, the voltage drop being proportional to the current drawn by the motor 40. One skilled in the art would recognize that other means of measuring the voltage drop, including using the motor 40 as the resistor, are within the scope of the present application.

The signal from the sensor circuit 24 may be conditioned by a filter 30 to remove noise and thus improve signal quality. Noise may result from, for example, current feedback in the sensor circuit 24 or drive circuit 20. In one embodiment, the filter 30 comprises a fourth order RC filter, although one skilled in the art would readily recognize that other filters 30, such as RC filters of different orders, or no filter 30 at all, may be advantageously used.

The sensor circuit signal, whether filtered or not, may pass through an A/D converter 82 and then used as an input to a control algorithm 84 (discussed in detail below). The control algorithm 84 may compare the signal to predetermined values to determine the operating condition of the motor 40. The controller 80 may then either allow the power supply 22 to continue providing the electrical current to the motor 40, or to shut off the current. One or more timers 86 may provide additional inputs to the control algorithm 84. For example, the timer 86 may measure the amount of time the power supply 22 provides electrical current to the motor 40. In one embodiment, the control algorithm 84 determines the operating condition of the motor 40 based on both the sensor circuit signal and the amount of time the electrical current has been provided to the motor 40.

The control algorithm 84 is predicated on several assumptions. First, the motor 40 is being used for an operation having a discrete starting point and a discrete ending point. For example, one operation that may benefit from the control algorithm 84 is moving a latch between engaged and unengaged positions. Second, an amount of time the motor 40 needs to run to complete the operation is known. For the latch example, the time needed to move the latch from one position to another will be known. Therefore, a time limit (Tₘₐₓ) greater than the known time can be established, and running the motor 40 for a period of time greater than Tₘₐₓ indicates a possible malfunction.

Next, the current (I) required to run the motor 40 under different conditions is known, and this allows one or more error situations to be tested. The current drawn by the motor 40 under “normal” conditions is the lowest current that is seen during operation of the motor 40. Normal conditions means that the component or subsystem is operating as intended and there are no jams, broken gears, etc. that affect the amount of current drawn by the motor 40. The next greater amount of current drawn by the motor 40 is an error limit (Iₑᵣᵣ) that may occur when some factor causes the component or subsystem to operate at less than normal conditions (e.g., a gear is binding up which causes a gear train to operate at a higher level of torque than without the gear binding up). A current level greater than Iₑᵣᵣ is an indication that there may be a malfunction. Proper operation of the motor 40 and the component or subsystem can be tested for an initial period by comparing the current drawn by the motor 40 to Iₑᵣᵣ. Thus, the motor 40 can be stopped if there is an initial malfunction in order to limit or prevent damage to the motor 40 or the component or subsystem. The initial period during which this test is performed is less than the known time to complete the operation. The highest known current drawn by the motor 40 occurs under a stall condition when the motor 40 is completely prevented from turning. A current limit Iₘₐₓ can be established to indicate a stall condition. The current limit Iₘₐₓ is typically set to a value slightly less than the stall current.

Finally, by using both the time limit Tₘₐₓ and the current limit Iₘₐₓ, successful completion of the operation can be determined. After the initial period, a current greater than Iₘₐₓ that occurs prior to the time limit Tₘₐₓ indicates successful completion of the operation. However, exceeding the time limit Tₘₐₓ without exceeding the current limit Iₘₐₓ indicates a malfunction.

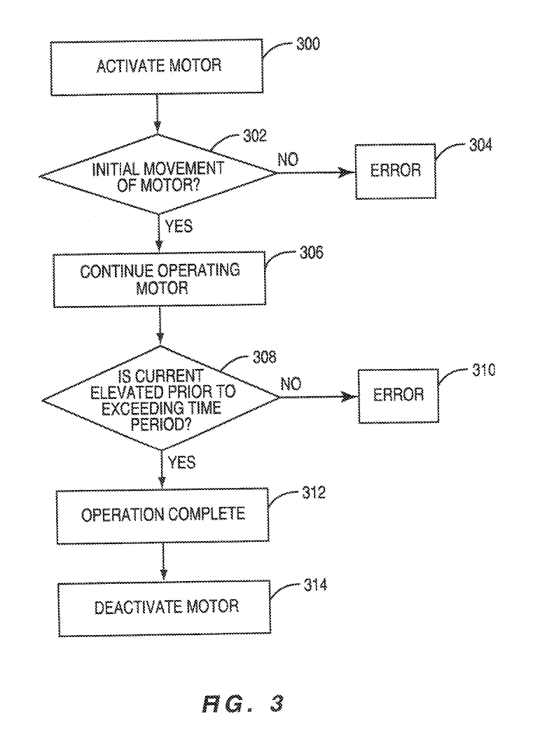

One embodiment of the control algorithm 84 is illustrated in FIG. 3. It should be noted that at initial power up of the image forming device 10 and prior to initiating the control algorithm 84, the controller 80 may activate the motor 40 for a period of time to drive the motor (or the subsystem or component driven by the motor 40) in a predetermined direction to a home position. During this movement, any exceedances of Iₑᵣᵣ, Iₘₐₓ, and Tₘₐₓ may be ignored so that the home position may be obtained. Following this startup procedure, the controller 80 sends a signal to activate the motor 40 (step 300), and the power supply 22 begins to supply electrical current to the motor 40. The timer 86 is also started to measure the total cumulative time (T) that the power supply 22 provides current (I) to the motor 40. In step 302, the movement of the motor 40 is checked by comparing the current drawn by the motor 40 to the error level Iₑᵣᵣ. This check is performed during an initial period of time immediately after activating the motor 40. The initial period of time is less than the known amount of time needed to complete the operation. As discussed above, Iₑᵣᵣ is greater than the amount of current the motor should normally draw during the operation, but less than the stall current. If the current is above Iₑᵣᵣ during the initial period, then a counter is started, and the current is monitored while the counter is running. If the current remains above Iₑᵣᵣ when the counter reaches a predetermined value C₁, then a malfunction has occurred (step 304). The motor 40 is deactivated, and a message may be displayed for the user.

If the motor current does not exceed Iₑᵣᵣ during the initial period (or falls below Iₑᵣᵣ prior to the counter reaching C₁), then the motor 40 continues operating (step 306). Monitoring of the current to the motor 40 and the total cumulative time continues. If the current exceeds Iₘₐₓ and the total cumulative time is less than Tₘₐₓ (step 308), then a second counter is started, and the current is monitored while the second counter is running. If the current remains above Iₘₐₓ when the second counter reaches a predetermined value C₂, then the operation is deemed to be successfully completed (step 312) and the motor 40 is deactivated (step 314). However, a malfunction may prevent the operation from completing and prevent the motor 40 from ever reaching a stall condition. For example, a gear within a gear train may become misaligned and no longer engage the next gear in the gear train. In this case, the motor 40 would continue to turn without effect. Thus, the total cumulative time would exceed Tₘₐₓ prior to the current exceeding Iₘₐₓ, indicating a malfunction (step 310). The motor 40 is deactivated and a message may be displayed for the user.

A specific embodiment of a subsystem 50 including a motor 40 that may utilize the motor control of the current application is illustrated in FIG. 4. The subsystem 50 of this embodiment may be used to position a latch (not shown) that secures a door of the image forming device 10 in a locked or unlocked position.

The subsystem 50 includes a gear train 25 including an enlarged control gear 14 with a stop feature 18 mounted on one side. In the embodiment of FIG. 4, the stop feature 18 includes a block that extends outward from a face of the control gear 14 and includes a first end 71 and a second end 72. A plate 17 is mounted adjacent to the control gear 14 to be contacted by the stop feature 18. In one embodiment, the plate 17 partially overlaps the control gear 14. The plate 17 may include a first straight surface and a second straight surface. The first straight surface may be positioned at an angle to the second straight surface. The stop feature 18 prevents further rotation of the control gear 14 when the first end 71 or second end 72 contacts the plate 17. Torque applied to the gear train 25 by motor 40 is thus constrained to those gears from the motor 40 to the control gear 14 because the rotational force of the control gear 14 is transferred to the plate 17. The gears downstream of the control gear 14 will be subjected to only a limited amount of torque when the first end 71 or second end 72 contacts the plate 17, which may prevent damage to those gears.

During use, the control gear 14 is positioned with the second end 72 of the stop feature 18 against the stop plate 17. The diameter of the control gear 14 is such that this corresponds to the latch being in one of the locked or unlocked positions, and the retraction assembly 27 being in one of an extended or retracted positions. In the embodiment of FIG. 4, this position places the latch in the unlocked position and the retraction assembly 27 in the retracted position. The motor 40 may then be activated to drive the control gear 14 to a second position with the first end 71 of the stop feature 18 contacting against the stop plate 17. This corresponds to the latch being in the opposite position as when the second end 72 is in contact with the stop plate 17. The amount of time the motor 40 is required to run to drive the control gear 14 to the second position is known and is used to determine the time limit Tₘₐₓ as described above for FIG. 3. In the embodiment of FIG. 4, the first end 71 in contact with the stop plate 17 places the latch in the unlocked position and the retraction assembly 27 in the retracted position.

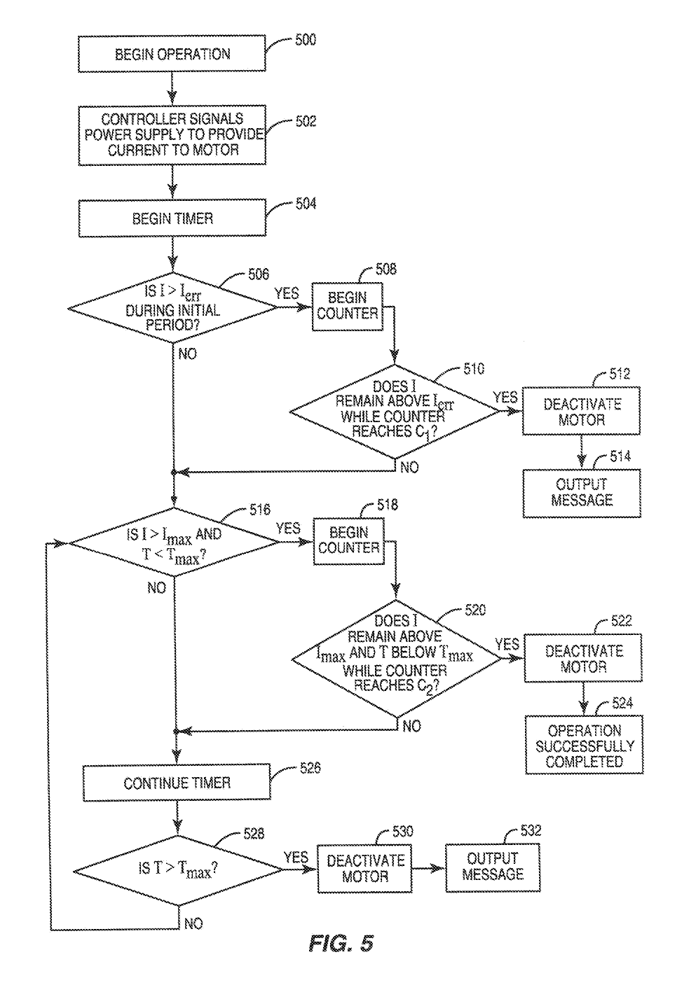

FIG. 5 illustrates how the motor control algorithm 84 may be applied to the specific subsystem 50 of FIG. 4. The algorithm starts when an operation involving the motor 40 begins (step 500), such as closing a door that is to be latched. The operation may be initiated by the controller 80 sensing that the door has been closed, or by a user entering commands through a control panel (not shown) on the image forming device 10. The controller 80 in turn signals the power supply 22 to provide electrical current to the motor 40 (step 502). Concurrent with the power supply 22 providing electrical current to the motor 40, the timer 86 starts (step 504). The timer 86 provides a cumulative count of the total time T the power supply 22 has provided electrical current to the motor 40.

Steps 506 through 514 cover the check of the movement of the motor 40 during the initial period. As described above the initial period begins when current is supplied to the motor 40 and ends after a period of time less than it takes for the motor 40 to drive the control gear 14 to the second position. The purpose of the initial check is to determine whether there is an immediate malfunction of the motor 40 or gear train 25 so that the current to the motor 40 can be shut off and damage minimized. The initial check begins by comparing the current I drawn by the motor 40 to the error limit Iₑᵣᵣ (step 506). If the current exceeds Iₑᵣᵣ, a counter is started (step 508). The high current level may be caused, for example, by debris trapped in the gear train 25 that inhibits movement of the gears, but does not totally stop movement. Monitoring of the current level continues to determine if the current remains above Iₑᵣᵣ for the entire period required for the counter to reach a predetermined value C₁ (step 510). If the current remains above Iₑᵣᵣ, then a malfunction has occurred during the initial period and the motor 40 is deactivated (step 512) by shutting off the power supply 22. A message may be displayed (step 514) to alert the user of the malfunction. Returning to step 510, if the current does not remain above Iₑᵣᵣ, then no malfunction has occurred and the algorithm 84 continues.

After the initial test, the motor 40 continues to drive the control gear 14 and moves the second end 72 closer to the edge of stop plate 17. Meanwhile, the current and time are monitored, and the algorithm determines whether the movement of the second end 72 to the edge of the stop plate has been completed. This corresponds to steps 516 through 524. When the movement has been completed, the motor 14 will be in a stall condition because the second edge 72 is against the edge of the stop plate 17, which prevents the motor 40 from turning. At this point, the current should exceed Iₘₐₓ and the time should be less than Tₘₐₓ (step 516). If so, a second counter is started (step 518). The second counter is required to make sure that the current remains above Iₘₐₓ and and not just a spike in the current. Once the second counter has reached a predetermined value C₂ and the current remains above Iₘₐₓ (step 520), the motor 40 is deactivated (step 522), and the operation is deemed to be complete (step 524). However, at step 520 if the current falls below Iₘₐₓ prior to the second counter reaching C₂, it is assumed that the second edge 72 has not reached the edge of the stop plate 17, and the process continues along with the timer (step 526).

Another type of malfunction may occur that allows the motor 40 to turn indefinitely without exceeding Iₘₐₓ. For example, gear 12 may become displaced so that gears 12 and 13 are no longer in contact. Thus, the control gear 14 is not rotated and the second edge 72 is not moved toward the edge of the stop plate 17. A test for a condition such as this is performed in steps 528 through 532. First, the total cumulative time T is compared to the time limit Tₘₐₓ (step 528). If Tₘₐₓ has been exceeded, then the operation has been performed for an amount of time greater than the known time to complete the operation. Thus, there must be a malfunction that is allowing the operation to run for an extended period. In response, the motor 40 is deactivated (step 530), and a message may be displayed (step 532) to alert the user of the malfunction. Returning to step 528, if Tₘₐₓ has not been exceeded, then the operation is allowed to proceed at step 516.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for controlling a motor in an image forming device, comprising:
applying a current to the motor for a period of time sufficient for the motor to complete a function in the image forming device;
monitoring an amount of current applied to the motor;
removing the current when the amount of current is approximately equal to a stall current of the motor; and
removing the current if the amount of current exceeds a predetermined error level prior to the period of time sufficient for the motor to complete the function, the predetermined error level less than the stall current of the motor.

2. The method of claim 1, wherein removing the current occurs when the current is approximately equal to the stall current of the motor and the current has been applied for a period of time sufficient for the motor to complete the function.

3. The method of claim 1, wherein removing the current when the amount of current is approximately equal to the stall current of the motor occurs when the amount of current is approximately equal to the stall current of the motor for a predetermined amount of time.

4. The method of claim 1, wherein monitoring the amount of current applied to the motor comprises monitoring a voltage drop across a resistor in a circuit providing the current to the motor.

5. The method of claim 1, wherein monitoring the amount of current applied to the motor comprises monitoring a voltage drop across the motor.

6. The method of claim 1, wherein the motor is a brush DC motor.

7. A method for controlling a motor in an image forming device, comprising:
applying a current to the motor to enable the motor to perform a function within the image forming device, wherein the function requires an expected amount of time to be completed;
monitoring an amount of current applied to the motor;
performing a check of the initial movement of the motor immediately after applying the current to the motor, comprising:
for a period of time less than the expected amount of time to perform the function, comparing the amount of current applied to the motor to a predetermined error level; and
removing the current if the amount of current exceeds the predetermined error level for the period of time less than the expected amount of time to perform the function; and
removing the current if the amount of current applied to the motor exceeds a maximum current.

8. The method of claim 7, wherein monitoring the amount of current applied to the motor comprises monitoring a voltage drop across a resistor in a circuit providing the current to the motor.

9. The method of claim 7, wherein comparing the amount of current applied to the motor to a predetermined error level comprises comparing the amount of current applied to the motor to a predetermined error level less than a stall current of the motor.

10. The method of claim 7, wherein removing the current if the amount of current applied to the motor exceeds a maximum current occurs when the amount of current applied to the motor is approximately equal to a stall current of the motor.

11. The method of claim 7, wherein removing the current if the amount of current applied to the motor exceeds a maximum current occurs when the amount of current applied to the motor exceeds a maximum current and a cumulative amount of time the current is applied to the motor is approximately equal to the amount of time to complete the function.

12. The method of claim 7, further comprising removing the current if a cumulative amount of time the current is applied to the motor exceeds the expected amount of time to perform the function prior to when the amount of current is approximately equal to a stall current of the motor.

13. The method of claim 7, wherein the motor is a brush DC motor.

14. A method for controlling a motor in an image forming device, comprising:
applying a current to the motor to enable the motor to perform a function within the image forming device, wherein the function requires an expected amount of time to be completed;
monitoring an amount of current applied to the motor;
performing a check of the movement of the motor immediately after applying the current to the motor, comprising:
for a period of time less than the expected amount of time to perform the function, comparing the amount of current applied to the motor to a predetermined error level;
starting a first counter if the amount of current is greater the predetermined error level; and
removing the current if the first counter reaches a predetermined value prior to the current falling below the predetermined error level; and
removing the current if the amount of current applied to the motor exceeds a maximum current.

15. The method of claim 14, wherein monitoring the amount of current applied to the motor comprises monitoring a voltage drop across a resistor in a circuit providing the current to the motor.

16. The method of claim 14, wherein comparing the amount of current applied to the motor to a predetermined error level comprises comparing the amount of current applied to the motor to a predetermined error level less than a stall current of the motor.

17. The method of claim 14, wherein removing the current if the amount of current applied to the motor exceeds the maximum current comprises:
comparing the amount of current applied to the motor to the maximum current;
starting a second counter if the amount of current applied to the motor is greater than the maximum current; and
removing the current if the second counter exceeds a predetermined value prior to the current falling below the maximum current.

18. The method of claim 17, wherein comparing the amount of current applied to the motor to the maximum current comprises comparing the amount of current applied to the motor to a stall current of the motor.

19. The method of claim 14, comprising removing the current when a cumulative amount of time the current is applied to the motor exceeds a maximum time limit and the current applied to the motor is less than a stall current of the motor.

20. The method of claim 14, wherein the motor is a brush DC motor.
